(19) United States
(12) Patent Application Publication
(10) Pub. No.: US 2008/0246305 A1
(43) Pub. Date: Oct. 9, 2008

(54) Arm rest for an automotive type door

(76) Inventor: Michael Church, Thaxton, VA (US)

Correspondence Address: JAMES RAY & ASSOCIATES, 2640 PITCAIRN ROAD, MONROEVILLE, PA, 15146, US

(21) Appl. No.: 12/079,479

(22) Filed: Mar. 27, 2008

Related U.S. Application Data
(60) Provisional application No. 60/908,241, filed on Mar. 27, 2007.

(51) Int. Cl. B60N 2/46

(52) U.S. Cl. 296/153

(57) ABSTRACT

An armrest for an automotive type door is provided. The armrest includes a frame member engageable with such automotive type door at a predetermined location thereon. Such frame member is manufactured from a first predetermined material and has a first predetermined size and a first predetermined shape. A padding member is manufactured from a second predetermined material and has a second predetermined size and a second predetermined shape. Such padding member is operably connected to such frame member at a predetermined location thereon.

### CROSS REFERENCE TO RELATED APPLICATION

This patent application is related to and claims priority from U.S. Provisional Patent Application Ser. No. 60/908,241 filed Mar. 27, 2007.

### FIELD OF THE INVENTION

The present invention relates, in general, to accessories for vehicles and, more particularly, this invention relates to padded arm rests for use in vehicles.

### BACKGROUND OF THE INVENTION

Prior to the conception and development of the present invention, arm rests, as are generally well known in the prior art, have been used inside vehicles to provide comfort to travelers. On occasion, however, the interior of the vehicle is less than comfortable for the occupants thereby creating the need for an armrest which can be placed in the vehicle at a user's convenience.

Specifically of interest to the present invention are the following: White, U.S. Pat. No. 4,592,584, provides an arm rest device for removable and adjustable attachment to a window well formed by a panel of an automobile or the like.

Grimes, U.S. Pat. No. 4,869,543, provides an armrest for a door of an automotive vehicle, including a molded shell having a substantially flat top wall portion and an interior shelf portion parallel to the flat top wall portion.

Harary, et al, U.S. Pat. No. 4,890,878 discloses an armrest to suspendingly engage within the window opening of an automobile door or other similar type of vehicular window. The armrest is to be adjustable to any desired position within the window opening. The armrest includes a fixed cushioning pad and a movably adjustable cushioning pad.

Sanders, U.S. Pat. No. 4,982,921 discloses a device for providing a comfortable resting surface for the arm of an automobile driver or passenger who would like to rest their arm on the lower surface of the window opening when the window is open.

Emley, U.S. Pat. No. 5,203,604 discloses a removable armrest for automobiles with removable tops and windows. The armrest conforms to the upper edge of the door. Engaging pins which correspond to engaging holes along the upper edge of the door when the windows are removed extend from the bottom of the armrest. The engaging pins slide into the engaging holes and securely hold the armrest in place when it is removably installed along the upper edge of the door.

### SUMMARY OF THE INVENTION

An armrest for an automotive type door is provided. Such armrest includes a frame member engageable with such automotive type door at a predetermined location thereon. The frame member is manufactured from a first predetermined material and has a first predetermined size and a first predetermined shape. A padding member is manufactured from a second predetermined material and has a second predetermined size and a second predetermined shape. The padding member is operably connected to the frame member at a predetermined location thereon.

### OBJECTS OF THE INVENTION

It is, therefore, one of the primary objects of the present invention to provide an armrest which can be attached to a vehicle at a user's convenience.

Another object of the present invention is to provide an armrest which can be added to a vehicle without interfering with such vehicle's door function.

Still another object of the present invention is to provide a comfortable armrest for travelers occupying a utilitarian style vehicle.

Yet another object of the present invention is to provide an easy to install armrest which can be retrofitted to vehicles lacking padded armrests.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective view of the invention according to one embodiment of the invention.

FIG. 4 is a partial cross-sectional view taken along the lines IV-IV of FIG. 2.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

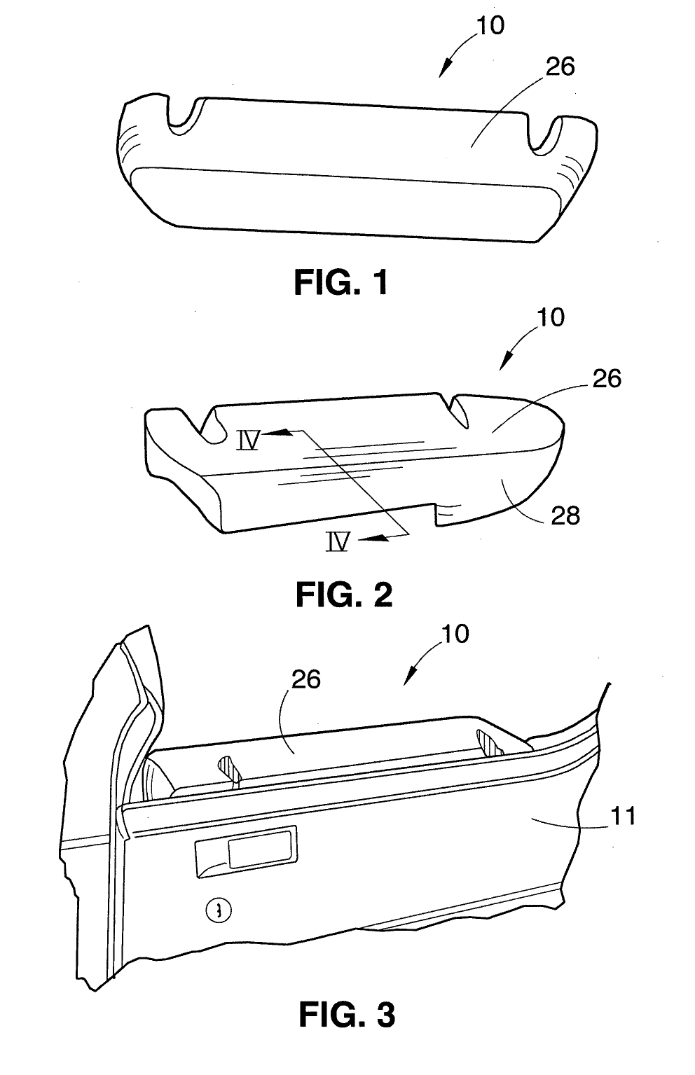

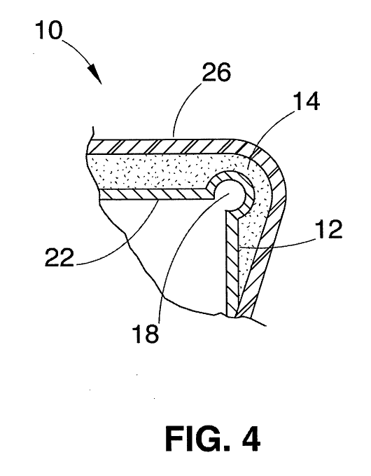

Reference is now made, more particularly, to FIGS. 1-4.

An armrest, generally designated 10, for an automotive type door 11 is provided. Such armrest 10 includes a frame member 12 engageable with such automotive type door at a predetermined location thereon. Such frame member 12 is manufactured from a first predetermined material and has a first predetermined size and a first predetermined shape.

It is presently preferred that such first predetermined material is at least one of metal, plastic, and wood. It presently most preferred that such first predetermined material is metal.

A padding member 14, manufactured from a second predetermined material and having a second predetermined size and a second predetermined shape, is operably connected to the frame member 12 at a predetermined location thereon.

It is presently preferred that such second predetermined material is at least one of foam, fabric, plastic, rubber and cellulose. It is presently most preferred that such second predetermined material is foam.

It is presently preferred that such armrest 10 further includes at least one of a cavity 18 disposed on an underside 22 of such armrest 10 at a predetermined location thereon, at least one recess (not shown) disposed on such armrest at a predetermined location thereon, and a combination thereof for receiving a predetermined portion of an automotive type door.

It is presently preferred that such armrest 10 further includes a covering member 26 for covering at least a portion of at least one of the frame member 12 and the padding member 14. It is further presently preferred that such covering member 26 is at least one of leather, fabric, vinyl, and plastic. It is presently most preferred that such covering member 26 is fabric.

It is presently preferred that such armrest 10 is between about 18.0 inches and 20.0 inches long. It is further presently preferred that such armrest 10 is between about 3.0 inches and 4.0 inches wide. It is additionally presently preferred that such armrest 10 is between about 1.5 inches and 3.6 inches high.

It is presently preferred that such armrest 10 has a height that is tapered along a width of such armrest 10.

It is presently preferred that such armrest 10 further includes a lip member 28 disposed at a predetermined location thereon.

The present invention is particularly useful for use within a Jeep® Wrangler TJ model manufactured between 1996 and 2006 by Chrysler, LLC, auburn Hills Mich., however, use of the invention is not meant to be limited to such model.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An armrest for an automotive type door comprising:
a. a frame member engageable with such automotive type door at a predetermined location thereon, said frame member being manufactured from a first predetermined material and having a first predetermined size and a first predetermined shape; and
b. a padding member manufactured from a second predetermined material and having a second predetermined size and a second predetermined shape, said padding member being operably connected to said frame member at a predetermined location thereon.

2. An armrest according to claim 1 wherein said armrest further includes a covering member for covering at least a portion of at least one of said frame member and said padding member.

3. An armrest according to claim 2 wherein said covering member is at least one of leather, fabric, vinyl, and plastic.

4. An armrest according to claim 3 wherein said covering member is fabric.

5. An armrest according to claim 1 wherein said first predetermined material is at least one of metal, plastic, and wood.

6. An armrest according to claim 5 wherein said first predetermined material is metal.

7. An armrest according to claim 1 wherein said armrest is between about 18.0 inches and 20.0 inches long.

8. An armrest according to claim 1 wherein said armrest is between about 3.0 inches and 4.0 inches wide.

9. An armrest according to claim 1 wherein said armrest is between about 1.5 inches and 3.6 inches high.

10. An armrest according to claim 1 wherein said armrest has a height that is tapered along a width of said armrest.

11. An armrest according to claim 1 wherein said armrest further includes at least one of a cavity disposed on an underside of said armrest at a predetermined location thereon, at least one recess disposed on said armrest at a predetermined location thereon and a combination thereof for receiving a predetermined portion of an automotive type door.

12. An armrest according to claim 1 wherein said second predetermined material is at least one of foam, fabric, plastic, rubber and cellulose.

13. An armrest according to claim 12 wherein said second predetermined material is foam.

14. An armrest according to claim 1 wherein said armrest further includes a lip member disposed at a predetermined location thereon.
